(19) United States
(12) Patent Application Publication
(10) Pub. No.: US 2006/0071082 A1
(43) Pub. Date: Apr. 6, 2006

(54) Print order sheet, information recording device, and print system

(75) Inventors: Tomoaki Tamura, TOKYO (JP); Takashi Igarashi, Tokyo (JP); Masataka Hasegawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA PHOTO IMAGING, INC., TOKYO (JP)

(21) Appl. No.: 10/535,906

(22) PCT Filed: Nov. 13, 2003
(86) PCT No.: PCT/JP03/14452

§ 371 Date: May 20, 2005

(30) Foreign Application Priority Data
Nov. 22, 2002 (JP) 2002-338949

(51) Int. Cl. G06K 19/00

(52) U.S. Cl. 235/487

(57) ABSTRACT

A print order form is provided for entering an order for a print of an image. The print order form includes a recording medium on which electrical information can be read or written in a non-contacting manner, and on which print order information of the image is recorded.

### TECHNICAL FIELD

The present invention relates to print order forms, information recording apparatuses, and print systems.

### BACKGROUND ART

In the recent years, printing services of preparing post cards with New Year or seasonal greetings or of preparing original calendars, etc., are being provided using photographed images recorded on films or image data recorded in recording media such as a CD-R, memory card, etc. The customer requiring such printing jobs can order them at the counters of photo shops or dealer shops by entering the necessary items in a print ordering form called a “staffer”. (See, for example, Japanese Patent Application Laid-Open No. Tokkaihei 6-123925.) This staffer not only has samples of decorative figures and patterns that can be used in the prints but is also provided with an order entry form for entering the details of the order such as the customer's name, contact details, number of prints, the decorative figures and patterns to be used, etc. When an order for prints is received by a photo shop or an agent shop, the staffer is submitted to a small scale developing laboratory (hereinafter referred to as a ‘minilab’) or to a large scale developing laboratory, and the printing is done in these laboratories based on the details of the order entered in the staffer.

However, in a printing service using the above described staffers, human errors in operation are easy to occur since the operator at the laboratory carries out the print production operations while visually checking the order details that have been written by hand in the staffers, and hence there was the problem that there was a likelihood of prints being produced that were different from those ordered by the customers. In addition, in the conventional printing service, since the necessary items have to be written in a new staffer for each order, the customer has to enter the details for each order even if they are the details (such as the name and contract details of the customer) that are common for several orders, and hence there was the problem that making entries in the staffers was a tedious task for the customers.

The task of the present invention is to improve the convenience of print order forms by the use of print order forms provided with IC tags.

### DISCLOSURE OF INVENTION

The print order form according to the present invention is a print order form for ordering prints of images with the feature that the print order form is provided with a recording medium permitting the reading from it and the writing to it of electronic information in a non-contacting manner and the print order information is recorded in the recording medium.

Further, in the print order form according to the present invention, it is preferable that information related to the person ordering the prints is included in the print order information recorded in the recording medium.

In addition, when the print order form according to the present invention is for an order for printing the images on material to be delivered (for example, post cards, direct mail, or envelopes), it is preferable that the print order information recorded in the recording medium includes information related to the recipient of the material to be delivered.

According to the print order form of the present invention, since it is provided with a recording medium permitting the reading from it and the writing to it of electronic information in a non-contacting manner and the print order information is recorded in the recording medium, it is possible to enhance the convenience of the print order form.

The information recording apparatus according to the present invention has the feature that it is provided in a print order form for ordering prints of images, and also can record the print order information of images in a recording medium permitting the reading from it and the writing to it of electronic information in a non-contacting manner.

Furthermore, it is preferable that information related to the party ordering the prints is included in the print order information recorded in the recording medium by the information recording apparatus according to the present invention.

Further, when the order of the prints is an order for printing the images on articles to be delivered, it is preferable that the print order information recorded in the recording medium by the information recording apparatus according to the present invention includes in it the information related to the recipient of the material to be delivered.

According to the information recording apparatus of the present invention, it is possible to enhance the convenience of the print order form by recording the print order information in the recording medium provided in the print order form.

The print system according to the present invention has the feature that it is provided to a print order form for ordering prints of images, and also that it comprises an information reading apparatus for reading out print order information from a recording medium permitting the reading from it and the writing to it of electronic information in a non-contacting manner, and a printing apparatus for printing on printing paper based on the print order information read out from the information reading apparatus.

Further, in the print system according to the present invention, it is preferable that the printing paper is provided with a recording medium permitting the reading from it and the writing to it of electronic information in a non-contacting manner, and an information recording apparatus that records a part of the print order information in the recording medium provided in the printing paper.

Using the print system according to the present invention, it is possible to carry out definitely the printing according to the customer's order by making it possible to read the print order information from the recording medium provided in the print order form.

### BRIEF DESCRIPTION OF DRAWINGS

FIG. 1 is a diagram showing a staffer 1 adopting the print order form according to the present invention;

FIG. 2 is a diagram showing the outline configuration of the order receiving system in a preferred embodiment of the present invention;

FIG. 3 is a block diagram showing the internal configuration of an IC tag 2, and the internal configuration of the reader and writer 3;

FIG. 4 is a block diagram showing the internal configuration of the order receiving apparatus 4 of FIG. 2;

FIG. 5 is a diagram showing the outline configuration of the print system 101 employing staffers having IC tags;

FIG. 6 is a block diagram showing the internal configuration of the PC 8 of FIG. 5;

FIG. 7 is a flow chart showing the order receiving process executed in the print system 100 of FIG. 2;

FIG. 8 is a flow chart showing the print generation process executed in the print system 101 of FIG. 5;

FIG. 9 is a diagram describing the scheme of preparing new staffers 1α and 1β from the staffer 1;

FIG. 10 is a diagram showing the outline configuration of the order receiving system 200 in the modified example 1 of the present preferred embodiment;

FIG. 11 is a diagram showing the outline configuration of the order receiving system 300 in the modified example 2 of the present preferred embodiment; and

FIG. 12 is a flow chart showing the order receiving process executed in the order receiving system 300 of FIG. 11.

### BEST MODE FOR CARRYING OUT THE INVENTION

In the following, some preferred embodiments of the present invention are described in detail referring to the drawings.

To begin with, the configuration of a preferred embodiment of the present invention is described here.

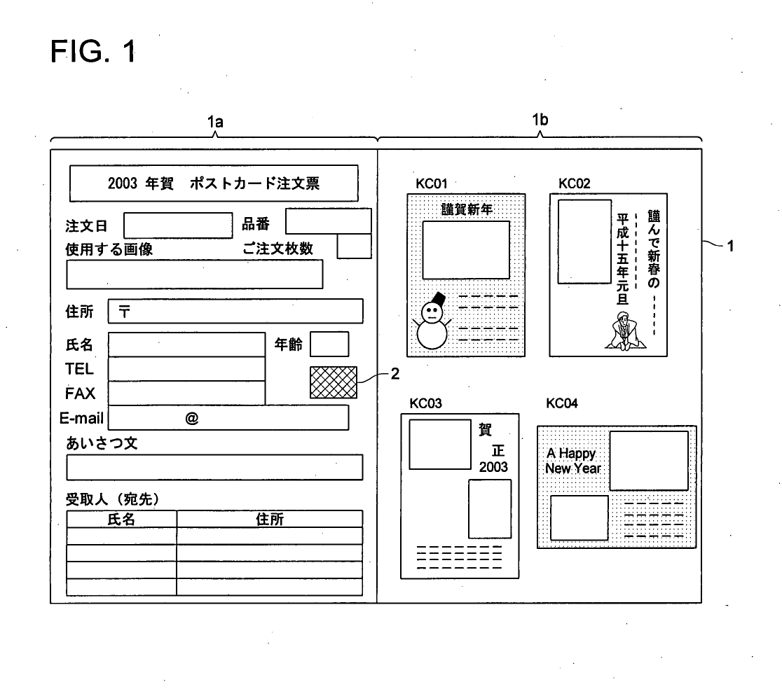

FIG. 1 is a diagram showing a staffer 1 adopting the print order form according to a preferred embodiment of the present invention. The staffer 1 is a print order form for ordering the printing of images or texts in post cards, and as is shown in FIG. 1, it is provided with the order details entry area 1a for entering the details of the order and the figures and patterns display area 1b which shows the decorative figures and patterns that can be used in the prints, and an IC tag 2 has been affixed at the right center part of the order details entry area 1a wherein the IC tag 2 is a recording medium permitting the writing to it and reading out from it electronic information in a non-contacting manner.

In the top right part of the order details entry area 1a are provided the order date entry column, item number entry column for specifying the figure and pattern to be selected and used from the figures and patterns shown in the figures and patterns display area 1b, a column for entering the information related to the image to be used in printing the post card, and a column for entering the number of prints being ordered. In addition, a column for specifying the type of original (film, photo print, digital, etc.) is provided in the column (not shown in the drawing) for entering the information related to the image to be used in printing the post card as well as a column for entering frame number in the film along with the folder name and the file name storing the image data (in the case of digital image data).

Further, in the center part of the order details entry area 1a are provided columns for entering the name, age, address, telephone number (TEL), facsimile number (FAX), and E-mail address as the information related to the sender of the post card. In addition, in the present preferred embodiment, the sender of the post card is assumed to be the same person as the person ordering the prints (hereinafter referred to as the print ordering customer).

Furthermore, a column is provided below the column for entering the sender's information for entering the greeting message to be used in the post card. Also, in the bottom part of the order details entry area 1a are provided columns for entering the name and address of the recipient of the post card. Text entry blocks (not shown in the drawing) of specific lengths corresponding to the number of characters are provided for each entry column in the order details area 1a, and one character has to be entered in each block.

The pluralities of decorative figures and patterns that can be printed are displayed in the figures and patterns display area 1b and an item number (KC01 etc.) for identifying the figure or pattern are printed for each figure or pattern.

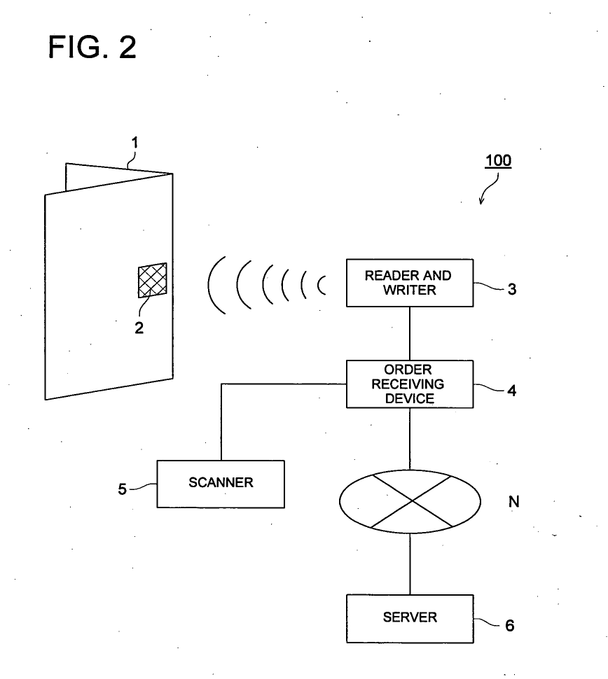

Next, the configuration of the order receiving system 100 employing staffers 1 is described here. FIG. 2 is a diagram showing the outline configuration of the order receiving system in a preferred embodiment of the present invention. The order receiving system 100, as is shown in FIG. 2, is constituted by a reader and writer 3 compatible with the information recording apparatus according to the present invention, an order receiving apparatus 4, a scanner 5, and a server 6. The order receiving apparatus 4 is connected to the reader and writer 3 and to the scanner 5. Further, the order receiving apparatus 4 is connected to the server 6 via the communication network N. In the following the reader and writer 3, the order receiving apparatus 4, and the scanner 5 are placed in the photo shop or in the agent shop, and the server 6 is placed in the minilab.

Here, the communication network N is, for example, a communication line network such as a LAN (Local Area Network) or a WAN (Wide Area Network), and comprises a plurality of independent leased lines, or public switched lines such as ordinary telephone lines, or ISDN (Integrated Services Digital Network) lines capable of transmitting digital data.

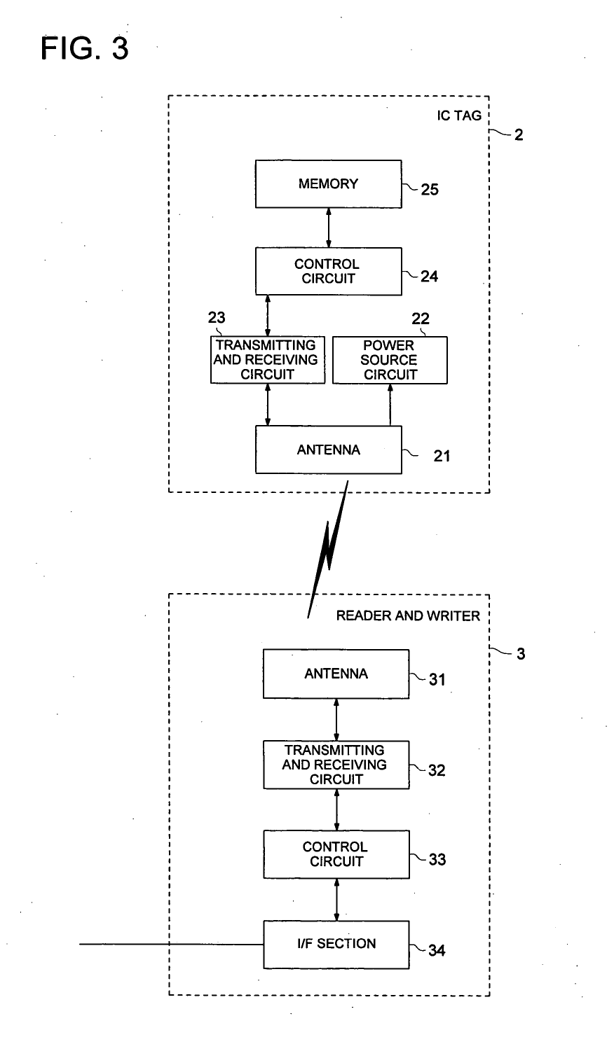

Next, the internal configurations of the IC tag 2 and of the reader and writer 3 are described here. FIG. 3 is a block diagram showing the internal configuration of an IC tag 2, and the internal configuration of the reader and writer 3. The IC tag 2 is constituted by the antenna 21, the power supply circuit 22, the transmitter and receiver circuit 23, the control circuit 24, and the memory 25.

The antenna 21 is provided with a coil antenna and receives the electromagnetic wave signals transmitted by the reader and writer 3. In addition, the antenna 21 transmits the signal input from the transmitter and receiver circuit 23 to the reader and writer 3.

The power supply circuit 22 converts the electromagnetic waves received from the reader and writer 3 via the antenna 21 to electric power and supplies the power to the different sections of the IC tag 2.

The transmitter and receiver circuit 23 decodes the signal received from the reader and writer 3 via the antenna 21. In addition, the transmitter and receiver circuit 23 modulates and amplifies the information (signal) read out from the memory 25 by the control circuit 24 and outputs it to the antenna 21.

The control circuit 24 carries out the writing (recording) operation to the memory in accordance with the input signal from the transmitter and receiver circuit 23. In addition, the control circuit 24 carries out the operation of reading out the information recorded in the memory 25, and outputs a signal indicating the modulation and amplification of the read out information (signal) to the transmitter and receiver circuit 23.

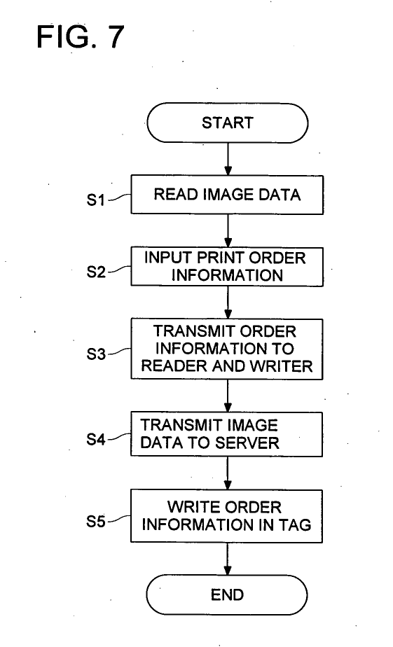

The memory 25 stores various types of information as a result of writing operation by the control circuit 24. The contents recorded in the memory 25 are the print order information recorded by the order accepting process shown in FIG. 7. The recording format of the print order information recorded in the memory 25 can be the DPOF (Digital Print Order Format) or the PPML (Personalized Print Markup Language).

Further, the communication method (electromagnetic induction method, microwave method, etc.) used for the IC tag 2 is not particularly restricted.

Next, the internal configuration of the reader and writer 3 is described here. The reader and writer 3 is a fixed type or a portable type reader and writer, and, as is shown in FIG. 3, is constituted by the antenna 31, the transmitter and receiver circuit 32, the control circuit 33, and the I/F section 34.

The antenna 31 receives the signal transmitted from the IC tag 2. Also, the antenna 31 transmits the signal input from the transmitter and receiver circuit 32 to the IC tag 2.

The transmitter and receiver circuit 32 decodes the signal received from the IC tag 2 via the antenna 31. Also, the transmitter and receiver circuit 32 modulates and amplifies the signal to be transmitted to the IC tag and outputs it to the antenna 31.

The control circuit 33 outputs to the I/F section 34 the instruction signal for outputting the signal input from the transmitter and receiver circuit 32 to the order receiving apparatus 4. In addition, the control circuit 33 outputs to the transmitter and receiver circuit 32 the instruction signal for carrying out modulation application of the signal transmitted to the IC tag 2.

The I/F section 34 is an interference for carrying out communication between the order receiving apparatus 4 and the reader and writer 3, and is provided with, for example, pins for an USB port or an RS-232C port.

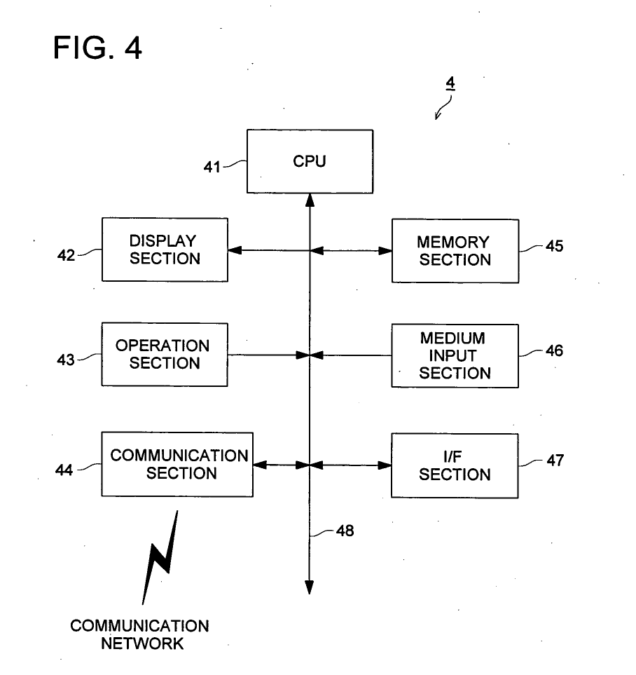

Next, the internal configuration of the order receiving apparatus 4 of FIG. 2 is described here. FIG. 4 is a block diagram showing the internal configuration of the order receiving apparatus 4. As is shown in FIG. 4, the order receiving apparatus 4 is constituted by the CPU (Central Processing Unit) 41, the display section 42, the operation section 43, the communication section 44, the storage section 45, the media input section 46, and the I/F section 47, and each of these sections are interconnected by a bus 48.

The CPU 41 carries out control of the different sections of the order receiving apparatus 4 in accordance with a variety of control programs stored in the storage section 45.

The display section 42 comprises an LCD (Liquid Crystal Display) or a CRT (Cathode Ray Tube) display device, and carries out the necessary display processing in accordance with the display signal input from the CPU 41.

The operation section 43 has ten keys, cursor keys, and various types of function keys and outputs the operation signal based on the key depressions to the CPU 41. In addition, the operation section 43 has a pointing device such as a mouse and outputs the operation signals due to the clicking operations of the mouse to the CPU 41. Further, the operation section 43 can also be constituted by a touch panel that is provided covering the display screen surface of the display section 42. This touch panel detects the coordinates instructed by touching based on the coordinating reading principles according to the electromagnetic induction method, the magnetic distortion method, or the pressure sensing method, etc., and outputs the detected coordinates as a position signal to the CPU 41.

The communication section 44 is configured using a modem (MODEM: Modulator/DEModulator), a terminal adapter (TA), or a LAN adapter, etc., and carries out communication control for communicating with external equipment via the communication network N of telephone lines, ISDN lines, or leased lines.

The storage section 45 has a recording medium (not shown in the drawing) in which programs or data have been stored beforehand, and this recording medium stores various types of control programs such as the order receiving process program, etc., executed by the CPU 41 and the data used during the execution of these control programs.

The medium input section 46 is configured so that it is possible to insert or remove a memory card such as a Memory Stick™, a Smart Media™, a Compact Flash™, a Multimedia Card™, an SD Memory Card™, a PC card, etc.

The I/F section 47 is the interface for carrying out communication between the order receiving apparatus 4 and the reader and writer 3, and, for example, has pins for an USB port or an RS-232C port.

In FIG. 2, the scanner 5 is constituted by a light source, a CCD (Charge Coupled Device), and an A/D converter, etc., and operates so that the light from the light source is reflected from the original document placed on the document table (glass sheet), this reflected light is converted into an electrical signal (analog signal) by the CCD, and this analog signal is converted into digital data by the A/D converter.

The server 6 stores the image data received from the order receiving apparatus 4 via the communication network N. In addition, the server 6 stores the data of the print order information received from the terminals (the PC 8 etc., described later) in minilabs.

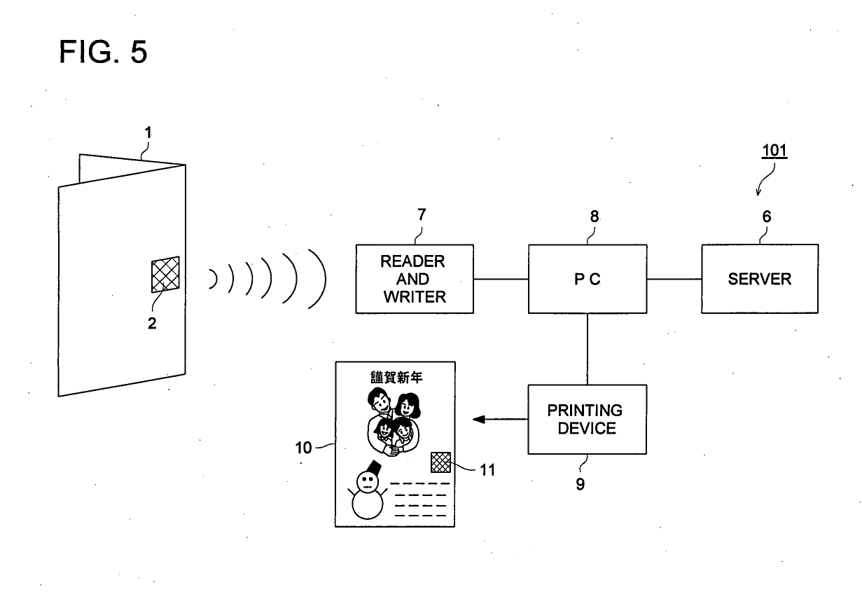

FIG. 5 is a diagram showing the outline configuration of the print system 101 in a minilab. The print system 101, as is shown in FIG. 5, is constituted by the server 6 (see FIG. 2), the reader and writer 7 corresponding to the information reading apparatus and the information recording apparatus according to the present invention, the PC (Personal Computer) 8, and the printing apparatus 9. The PC 8 is connected to the reader and writer 7 and to the printing apparatus 9. In addition, the PC 8 is connected to the server 6 via a communication network such as a LAN, etc.

The reader and writer 7 writes data to IC tag 2 and reads data from the IC tag 2 that has been affixed to the staffer 1. Detail description of the reader and writer 7 is omitted here because it has the same functions as the reader and writer 3 shown in FIG. 3.

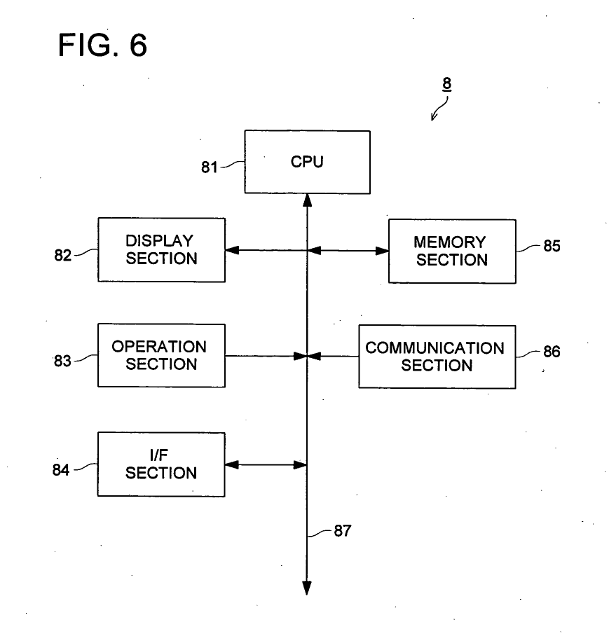

Next, the internal configuration of the PC 8 of FIG. 5 is described here. FIG. 6 is a block diagram showing the internal configuration of the PC 8. As is shown in FIG. 6, the PC 8 is constituted by the CPU 81, the display section 82, the operation section 83, the I/F section 84, the storage section 85, and the communication section 86, and each of these sections are interconnected via the bus 87.

The CPU 81 carries out control of the different sections of the PC 8 in accordance with various types of control programs stored in the storage section 85.

This CPU 81 generates the control signals for generating the prints based on the data of the print order information received from the reader and writer 7 and on the image data read in from the server 6. In addition, the CPU 81 carries out encoding operation of PGP (Pretty Good Privacy) for a part of the data (data of the payment method or of the recipient) of the order information received from the reader and writer 7.

The display section 82 is configured using an LCD or a CRT, etc., and carries out the necessary display operation in accordance with the display signal input from the CPU 81.

The operation section 83 has ten keys, cursor keys, and various types of function keys and outputs the operation signal based on the key depressions to the CPU 81. In addition, the operation section 83 has a pointing device such as a mouse and outputs the operation signals due to the clicking operations of the mouse to the CPU 81. Further, the operation section 83 may also be constituted by a touch panel that is provided covering the display screen surface of the display section 82. This touch panel detects the coordinates instructed by touching based on the coordinating reading principles according to the electromagnetic induction method, the magnetic distortion method, or the pressure sensing method, etc., and outputs the detected coordinates as a position signal to the CPU 81.

The I/F section 84 is the interface for carrying out communication between the PC 8 and the reader and writer 7, and, for example, has pins for an USB port or an RS-232C port.

The storage section 85 has a recording medium (not shown in the drawing) in which programs or data have been stored beforehand, and this recording medium stores various types of control programs such as the order receiving process program, executed by the CPU 81 and the data used during the execution of these control programs.

The communication section 86 is configured using a modem, a terminal adapter, or a LAN adapter, etc., and carries out communication control for communicating with external equipment via a communication network of telephone lines, ISDN lines, or leased lines.

In FIG. 5, the printing apparatus 9 prints and outputs on printing paper the image for which a printing instruction has been received from the PC 8 using a printing method such as the electro-photographic method or the inkjet method.

Next, the operation in the present preferred embodiment of the present invention is described below.

To begin with, referring to the flow chart shown in FIG. 7, the order receiving process executed in the order receiving system 100 is described here.

Consider that the customer ordering for prints brings the staffer 1 in which the necessary items have been entered along with the media or printed photographs in which the image data to be used for printing is recorded, and requests for the processing of receiving print orders at a photo shop or at an agent shop. When the customer brings a printed photograph, that photograph will be placed on the original document table of the scanner 6. When the customer brings a media such as a memory card in which the image data has been recorded, that media is inserted in the media input section 46 of the order receiving apparatus 4.

When the instructions of order receiving are input by making the necessary operations in the operation section 43, the entry form screen for entering the print order information is displayed in the display section 42. Assume that DPOF is being used as the entry format of print order information in this entry form screen.

Next, when the storage location (folder name and file name) of the image data to be used for printing is specified by making operations in the operation section 43 based on the image information entered in the order details entry area 1a of the staffer 1. The corresponding image data is read in from the media input section 46 (Step S1). When the customer has brought a printed photograph, the image data of the printed photograph placed on the original document table of the scanner 6 is read in. When the image data to be used for printing is read in, an identification number is assigned to that image data that has been read in and that identification number of the image data is entered in the image information entry column in the entry form screen.

Next, the print order information is input into the entry form screen by making operations in the operation section 43 (Step S2). The print order information input in Step S2 has, apart from the details entered in the order details entry area 1a of the staffer 1, the data of the print charges, the method of payment of print charges (cash, credit card, prepaid card, etc.), scheduled delivery date and time, scheduled date and time of order processing, campaign information, discount information, shipment route, identification number of staffer 1, etc. Further, it is also possible that the data of the identification number of the staffer 1 is recorded beforehand in the IC tag 2.

When the inputting of the order details in Step S2 is completed, the data of the print order information input in the entry form screen is transmitted to the reader and writer 3 via the I/F section 47 (Step S3). In addition, the image data and the data of its identification number are transmitted to the server 6 via the communication network N (Step S4). The data of the print order information is written (recorded) into the IC tag 2 affixed to the staffer 1 by the reader and writer 3, whereupon this order receiving process is completed.

Further, in the order receiving processing shown in FIG. 7, although the image data to be used in printing was sent to the server 6, when the IC tag 2 has capacity to record the image data, it is also possible to record the image data in the IC tag 2. In addition, in the order receiving processing shown in FIG. 7, although the print order information was input after the image data was read in, the timings of reading in the image data and of inputting the print order information are not limited in any way.

In addition, when the reader and writer 3 and the scanner 5 are not provided at the location of receiving a print order (such as at a print service agent shop), it is possible to send the staffer 1 in which the necessary items have been entered and the media in which the image data has been recorded or the photograph print to the location where it is possible to carry out the order receiving process of FIG. 7, and to execute the order receiving process of FIG. 7 at that location to which they have sent.

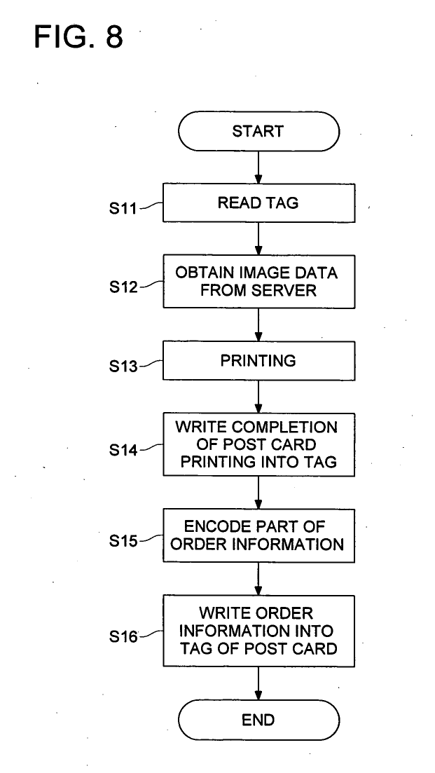

Next, referring to the flowchart shown in FIG. 8, the print generation processing executed in the print system 101 is described here.

Consider that the staffer 1 to which is affixed the IC tag 2 in which the print order information has been recorded by the order receiving process shown in FIG. 7 is sent to a minilab. To begin with, upon receiving a tag read out instruction from the PC 8 the data of the print order information recorded in the IC tag 2 of the staffer 1 is read out (Step S11) by the reader and writer 7, and the data of that read out print out information is transmitted to the PC 8. The data of the print order information read out in Step S11 is stored in the storage section 85. Further, it is also possible to transmit this data of the print order information to the server 6 and to store in the server 6.

Next, the data of the identification number of the image data is extracted from the data of the print order information read in from the IC tag 2, and the image data corresponding to this identification number is read in from the server 6 (Step S12).

Next, based on the data of the print order information read in from the IC tag 2 and the image data read in from the server 6, a control signal for generating the prints is generated and is transmitted to the printing apparatus 9. In the printing apparatus 9, in accordance with the control signal from the PC 8, printing of the address on the stamp side, printing of the image and the sender's details on the reverse side (the message side) are made (Step S13), thereby producing the post card 10. The IC tag 11 would have been affixed beforehand to the post card 10. Further, in Step S13, it is also possible to issue a post card with IC tag to be retained by the person placing the print order.

When the printing is completed in Step S13, the data of the information reporting the fact that the production of the post card has been completed (production completion information) is transmitted to the reader and writer 7 via the I/F section 84. This data of production completion information is written into the IC tag 2 of the staffer 1 by the reader and writer 7 (Step S14).

Next, the data that do not need to be posted to the recipient, such as the data of the payment method or of the recipient etc., is extracted from the data of the print order information read out from the IC tag 2, and encoding operation such as PGP is carried out for this extracted data (Step S15).

Further, the data of the print order information in which the part of the information has been encoded is transmitted to the reader and writer 7. This data of the print order information in which the part of the information has been encoded is written by the reader and writer 7 into the IC tag 11 affixed to the post card 10 produced in Step S13 (Step S16), whereupon this print generation processing is completed. Also, it is possible to make it possible to select the data to be recorded in the IC tag 11 of the post card 10 from the data recorded in the IC tag 2 of the staffer 1.

When the print generation process of FIG. 8 is completed, the procedure executed for sending the staffer 1 and the produced post card 10 (including the post card to be retained by the person ordering the print). When the person placing the print order is to pick up the staffer 1 and the produced post card 10 at the agent shop, the procedure is carried out for sending them to the specified agent shop. In addition, at this time, the processing for settling the payment of the print charges is carried out based on the data of the print order information obtained from the IC tag 2 of the staffer 1.

The person ordering the print who has received the staffer 1 can use that staffer 1 to place orders for additional prints at a later date. In this case, it is sufficient to modify only the data of the number of prints ordered, the age of the sender (counting up of the age), etc., among the data recorded in the IC tag 2. Further, it is desirable to leave a print order history for several years in the IC tag 2 of the staffer 1. By doing so, it becomes possible to confirm the years during which a post card was sent and the years during which a post card was sent.

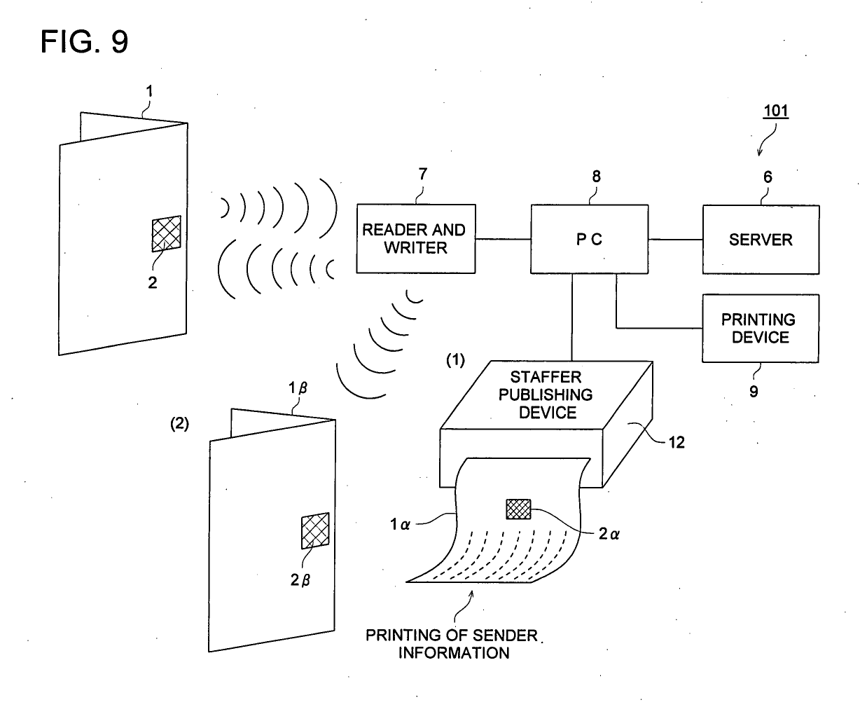

In addition, when the print system 101 is equipped with a staffer issuing apparatus 12 as is shown in FIG. 9, after the production of the post card 10, it is also possible, as is shown in FIG. 9(1), to issue a new staffer 1α from the staffer issuing apparatus 12 connected to the PC 8, and to hand over this a new staffer 1α to the person ordering the print. The IC tag 2α is affixed to the new staffer 1α, and not only the latest decorative figure or pattern is printed out but also the information related to the sender (name, age, address, telephone number, facsimile number, and e-mail address) from among the information read out from the IC tag 2 of the staffer 1 is also printed out.

In addition, after the production of the post card 10, it is possible, as is shown in FIG. 9(2), to record the data recorded in the IC tag 2 of staffer 1 in the IC tag 2β of the staffer 1β having the latest decorative figure or pattern, and to hand over this new staffer 1β to the person ordering the print. In this case, it is also possible to destroy the data recorded in the IC tag 2 by applying a high voltage to the IC tag 2 of the old staffer 1. By doing so, it is possible to prevent leakage of the data recorded in the IC tag 2 of the old staffer 1.

In the above manner, according to the staffer 1 of the present preferred embodiment, it is possible to enhance the convenience of the staffer 1 because of affixing the IC tag 2. In addition, it is possible to carry out definitely the printing according to the customer's order by writing the print order information in the IC tag 2 using the reader and writer 3 and carrying out the print generation based on the print order information recorded in the IC tag 2.

Further, since it is possible to use a part of the contents recorded in the IC tag 2 of the staffer 1 at the time of ordering additional prints and to modify as and when necessary the contents recorded in the IC tag 2, it is possible to use the staffer 1 effectively.

Furthermore, by affixing an IC tag 11 to the post card 10 produced in a minilab, and by writing the data of the sender's information etc., in this IC tag 11, the person receiving this post card 10 can easily create an address book using the sender's information recorded in the IC tag 11.

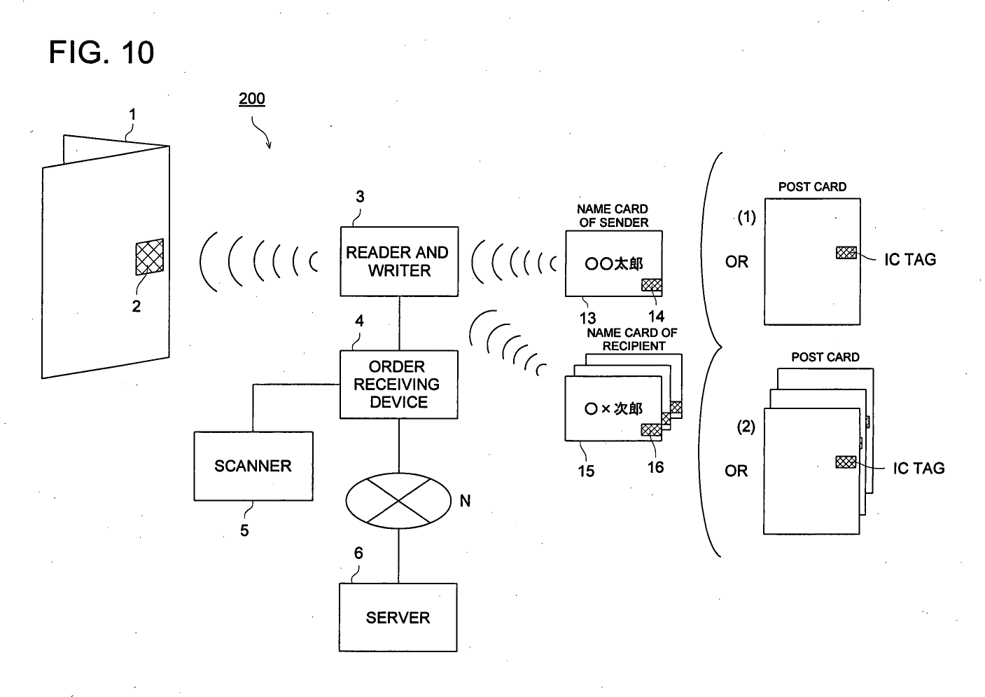

Next, referring to FIG. 10 to FIG. 12, some modified examples of the order receiving system 100 are described here. Also, in the following description, the constituent parts identical to those in the order receiving system 100 described above have been assigned the same symbols.

### MODIFIED EXAMPLE 1

To begin with, referring to FIG. 10, the order receiving system 200 of the modified example 1 is described here. In the preferred embodiment described above, although the order details entered in the staffer 1 were being obtained by the inputting operations made in the operation section 43 by a shop attendant in a photo shop or an agent shop, in the modified example 1, a part of the order details (for example, the data related to the sender, the data related to the recipient, etc.,) or the whole of the order details are obtained automatically from the recorded media.

FIG. 10 shows the order receiving system 200 using the staffer 1, the name card 13 of the sender of the post card, and the name card 15 of the receiver. Since the outline configuration of the order receiving system 200 shown in FIG. 10 is the same as the order receiving system 100 described above, its description will be omitted here.

The data of the sender's name, address, telephone number, facsimile number, and e-mail address of the post card is recorded in the IC tag 14 affixed to the name card 13 of the sender shown in FIG. 10. Also, the data of the recipient's name, address, telephone number, facsimile number, and e-mail address of the post card is recorded in the IC tag 16 affixed to the name card 15 of the recipient.

In the order receiving system 200 of FIG. 10, during the Step S2 of the order receiving process of FIG. 7, the information related to the sender and the recipient of the post card (name, address, telephone number, facsimile number, and e-mail address) among the print order information are input by reading in the data recorded in the IC tag 14 and the IC tag 16 by the reader and writer 3.

According to the print order receiving system 200 in the modified example 1, because the information related to the sender of the post card is obtained from the IC tag 14 affixed to the name card 13 of the sender, and because it has been made possible to obtain the information related to the recipient of the post card from the IC tag 16 attached to the name card 15 of the recipient, it is possible to eliminate the trouble of inputting the information related to the sender and the receiver among the print order information, thereby making it is possible to prevent inputting mistakes and to achieve high efficiency of order reception.

Further, in the modified example 1, although the information related to the recipient of the post card is being obtained from the IC tag 16 affixed to the name card 15 of the recipient, if a post card (the post card 10 shown in FIG. 5) produced by the print generation process of FIG. 8 has been sent in the past from that recipient, as is shown in FIG. 10(2), it is also possible to obtain the information related to the recipient from the IC tag affixed to that old post card. In addition, as is shown in FIG. 10(1), when there is a post card with an IC tag affixed to it and in which the information related to the sender has been recorded (for example, a post card with IC tag for retaining by the person ordering the print), it is also possible to obtain the information related to the sender from the IC tag affixed to that old post card.

### MODIFIED EXAMPLE 2

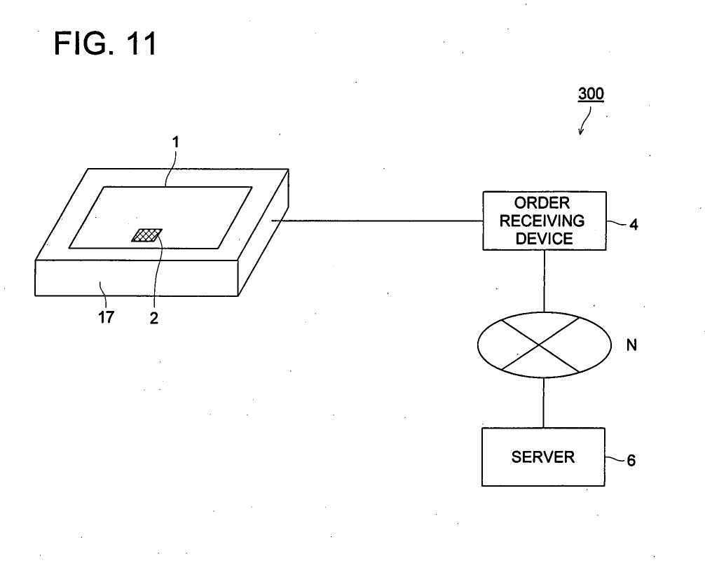

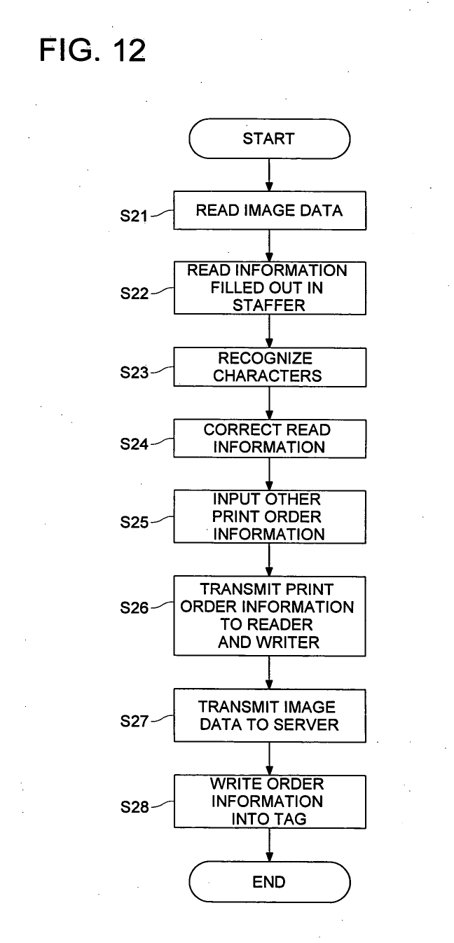

Next, the order receiving system 300 in the modified example 2 is described here referring to FIG. 11 and FIG. 12. In the modified example 2, the details of the order are obtained by scanning using a scanner the details entered in the print details entry area 1a of the staffer 1.

FIG. 11 is a diagram showing the outline configuration of the order receiving system 300 using the staffer 1 in the modified example 2 of the present preferred embodiment. As is shown in FIG. 11, the order receiving system 200 is constituted by the reader and writer/scanner apparatus 17, the order receiving apparatus 4, and the server 6. The order receiving apparatus 4 is connected to the reader and writer/scanner apparatus 17, and is also connected to the server 6 via the communication network N. In FIG. 11, the reader and writer/scanner apparatus 17 is a flat-bed scanner with a built-in reader and writer unit.

Next, the order receiving process executed in the order receiving system 300 is described here while referring to the flow chart shown in FIG. 12.

Consider that the customer ordering for prints brings a staffer 1 in which the necessary items have been entered along with a medium in which image information has been recorded or photograph prints, and asks the shop counter in a photo shop or an agent shop to receive the print order. This staffer 1 is placed on the original document table of the reader and writer/scanner apparatus 17 with the order details entry area 1a facing down. When the customer has brought along a photograph print, even that photograph print is placed face down on the original document table of the reader and writer/scanner apparatus 17. When the customer has brought along a memory card etc., in which image data has been recorded, that medium is inserted in the media input section 46.

Next, when the storage location (folder name and file name) of the image data to be used for printing is specified by making operations in the operation section 43 based on the image information entered in the order details entry area 1a of the staffer 1, the corresponding image data is read in from the media input section 46 (Step S21). When the customer has brought a printed photograph, the image data of the printed photograph placed on the original document table of the reader and writer/scanner 17 is read in. When the image data to be used for printing is read in, an identification number is assigned to that image data that has been read in, and that identification number of the image data is entered in the image information entry column in the entry form screen.

Next, when the information entered in the order details entry area 1a of the staffer 1 is read in from the reader and writer/scanner 17 (Step S22), character recognition is carried out based on the read in data (Step S23), and the information obtained by character recognition is displayed on the display screen.

Next, the shop attendant compares the information entered in the order details entry area 1a of the staffer 1 with the information displayed in the display screen, and the part that was not recognized correctly by character recognition is corrected in the entry form screen using input operations in the operation section 43 (Step S24).

Next, the print order information other than the print order information entered in the order details entry area 1a of the staffer 1 is input into the entry form screen by making operations in the operation section 43 (Step S25). The print order information input in Step S25 comprises, apart from the details entered in the order details entry area 1a of the staffer 1, the data of the print charges, the method of payment of print charges (cash, credit card, prepaid card, etc.), the scheduled dispatch date and time, the scheduled date and time of order processing, the campaign information, the discount information, the shipment route, the identification number of staffer 1, etc. Further, it is also possible that the data of the identification number of the staffer 1 is recorded beforehand in the IC tag 2.

When the inputting of the print order information in Step S25 is completed, the data of the print order information input in the entry form screen is transmitted to the reader and writer/scanner 17 via the I/F section 47 (Step S26). In addition, the image data and the data of its identification number are transmitted to the server 6 via the communication network N (Step S27).

The data of the print order information is written (recorded) into the IC tag 2 affixed to the staffer 1 by the reader and writer 3 (Step S28), whereupon this order receiving process is completed.

According to the print order receiving system 300 in the modified example 2, because it has been made possible to read in the details entered in the order details entry area 1a of the staffer 1 by the reader and writer/scanner 17, it is possible to eliminate the trouble of inputting the print order information, thereby making it is possible to prevent inputting mistakes and to achieve high efficiency of order reception.

Further, the order receiving process in the print order receiving system 300 of the modified example 2 can also be realized with a system configuration similar to the order receiving system 100 (see FIG. 2) and the order receiving system 200 (see FIG. 10). In other words, the details entered in the order details entry area 1a of the staffer 1 can read out by the scanner 5 in the order receiving systems 100 and 200, and the print order information can be written by the reader and writer 3 in the IC tag 2 of the staffer 1.

Furthermore, the descriptions given above for the preferred embodiments of the present invention can be modified appropriately without deviating from the intent and scope of the present invention. For example, in the preferred embodiments described above, although cases have been described in which the IC tag has been affixed on the staffer 1 or on the post card 10, it is also possible that the IC tag is embedded inside the paper constituting the staffer 1 or the post card 10. Further, in the preferred embodiments described above, although the cases have been described in which a non-contacting type of IC tag has been affixed to (or embedded inside) the staffer 1 or the post card 10, the present invention can also be applied with contacting type IC tags such as those similar to credit cards having IC cards.

Using print order forms according to the present invention, because a recording medium is provided that permits the reading out and writing in of electronic data in a non-contacting manner, and because print order information is recorded in said recording medium, it is possible to increase the convenience of print order forms.

Using the information recording apparatus according to the present invention, by recording the print order information in a recording medium provided in the print order form, it is possible to enhance the convenience of print order form.

Using a print system according to the present invention, because it has been made possible to read out print order information from a recording medium provided in the print order form, it is possible to carry out definitely the printing according to the customers' orders.

1-8. (canceled)

9. A print order form for entering an order for a print of an image, said print order form comprising:
a recording medium on which electrical information can be read or written in a non-contacting manner, and on which print order information of the image is recorded.

10. The print order form of claim 9, wherein the print order information recorded on the recording medium includes information related to an orderer.

11. The print order form of claim 9, wherein the order for the print comprises an order to print the image on an article to be delivered, and the print order information recorded on the recording medium includes information related to a recipient of the article to be delivered.

12. An information recording apparatus comprising:
a print order form for entering an order for a print of an image; and
a recording medium provided on the print order form, on which electrical information can be read or written in a non-contacting manner, and on which print order information of the image is recorded.

13. The information recording apparatus of claim 12, wherein the print order information recorded on the recording medium includes information related to an orderer.

14. The information recording apparatus of claim 12, wherein the order of the print comprises an order to print the image on an article to be delivered, and the print order information recorded on the recording medium includes information related to a recipient of the article to be delivered.

15. A printing system comprising:
a print order form for entering an order for a print of an image;
a recording medium provided on the print order form, on which electrical information can be read or written in a non-contacting manner;
an information reading device for reading print order information from the recording medium; and
a printing device for printing on a printing sheet of paper on the basis of the print order information which has been read by the information reading device.

16. The printing system of claim 15, wherein the printing sheet of paper comprises another said recording medium, and the printing system further comprises an information recording device for recording at least a part of the print order information on the recording medium of the printing sheet of paper.
